(19) United States
(12) Patent Application Publication
(10) Pub. No.: US 2009/0126535 A1
(43) Pub. Date: May 21, 2009

(54) POWER WRENCH

(75) Inventors: Chih-Hua Cho, Nantou County (TW); Hsin-Hung Li, Taichung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 11/968,310

(22) Filed: Jan. 2, 2008

(30) Foreign Application Priority Data
Nov. 16, 2007 (TW) 96143572

(51) Int. Cl. B25B 17/00

(52) U.S. Cl. 81/57.29

(57) ABSTRACT

A power wrench includes a body, a connecting element, a drive motor and a protection circuit. The connecting element is axially rotatably disposed inside the body and protrudes out of the body. The drive motor is for rotating the connecting element. The protection circuit is for controlling a power supply of the drive motor according to a value of a drive current of the drive motor. When the drive current of the drive motor is over a critical current value, the power supply of the drive motor is cut off.

This application claims the benefit of Taiwan application Serial No. 96143572, filed Nov. 16, 2007, the subject matter of which is incorporated herein by reference.

### BACKGROUND OF THE INVENTION

1. Field of the Invention

The invention relates in general to a power wrench, and more particularly to a power wrench capable of decreasing a reaction force.

2. Description of the Related Art

An ordinary user usually uses a wrench to screw a bolt in two stages. FIGS. 1A and 1B (Prior Art) are schematic illustrations showing a bolt being screwed and having been tightly screwed. As shown in FIG. 1A, the user wants to screw a bolt 2 into a screw hole 3a on a work surface 3. The bolt 2 includes a bolt bearing surface 2a. The stage after the bolt 2 is rotated to move by a height H and before the bolt bearing surface 2a touches the work surface 3 is referred to as a screw-in stage. As shown in FIG. 1B, after the screw-in stage is finished, the bolt 2 has to be continuously rotated until a set torque is reached in order to ensure a sufficient connection intensity between the bolt 2 and the object with the work surface 3, and this stage is referred to as a tightly screwing stage.

Typically, when the bolt 2 is in the screw-in stage, the resistant force withstood by the bolt 2 is not high. However, if the height H is longer and the threads of the bolt 2 are denser, the user has to rotate the bolt 2 many times. In order to save the manpower and prevent the user from performing the work needing no precision, a power wrench has been developed. The power wrench is a wrench with a power source and can finish the screw-in process quickly.

However, a reaction force is generated at the instant when the power wrench has finished the work in the screw-in stage to make the bolt bearing surface contact with the work surface. More particularly, when the power source with the high rotating speed and the large output power is adopted, the generated reaction force tends to twist the hand of the user. Thus, the currently available power wrench only has the power source for providing a small torque to prevent the user from being hurt when he or she is operating the power wrench.

### SUMMARY OF THE INVENTION

The invention is directed to a power wrench, which is properly designed to control a power supply of a motor so that a reaction force is generated at the instant when a screw-in stage ends and it is possible to prevent the user from being hurt.

According to the present invention, a power wrench including a body, a connecting element, a drive motor and a protection circuit is provided. The connecting element is axially rotatably disposed inside the body and protrudes out of the body. The drive motor is for rotating the connecting element. The protection circuit is for controlling a power supply of the drive motor according to a value of a drive current of the drive motor. When the drive current of the drive motor is over a critical current value, the protection circuit cuts off the power supply of the drive motor.

The invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a schematic illustration showing a bolt being screwed;

FIG. 1B (Prior Art) is a schematic illustration showing the bolt having been tightly screwed;

FIG. 2A is a top view showing a power wrench according to a first embodiment of the invention;

FIG. 2B is a cross-sectional view taken along a line A-A′ of FIG. 2A;

FIG. 3 is a side view showing a protection circuit of a motor;

FIG. 4A is a schematic illustration showing a first switched state of a limit switch of a limiting element;

FIG. 4B is a schematic illustration showing a second switched state of the limit switch of the limiting element;

FIG. 4C is a schematic illustration showing a third switched state of the limit switch of the limiting element; and

FIG. 5 is a cross-sectional view showing a power wrench according to a second embodiment of the invention.

### DETAILED DESCRIPTION OF THE INVENTION

### First Embodiment

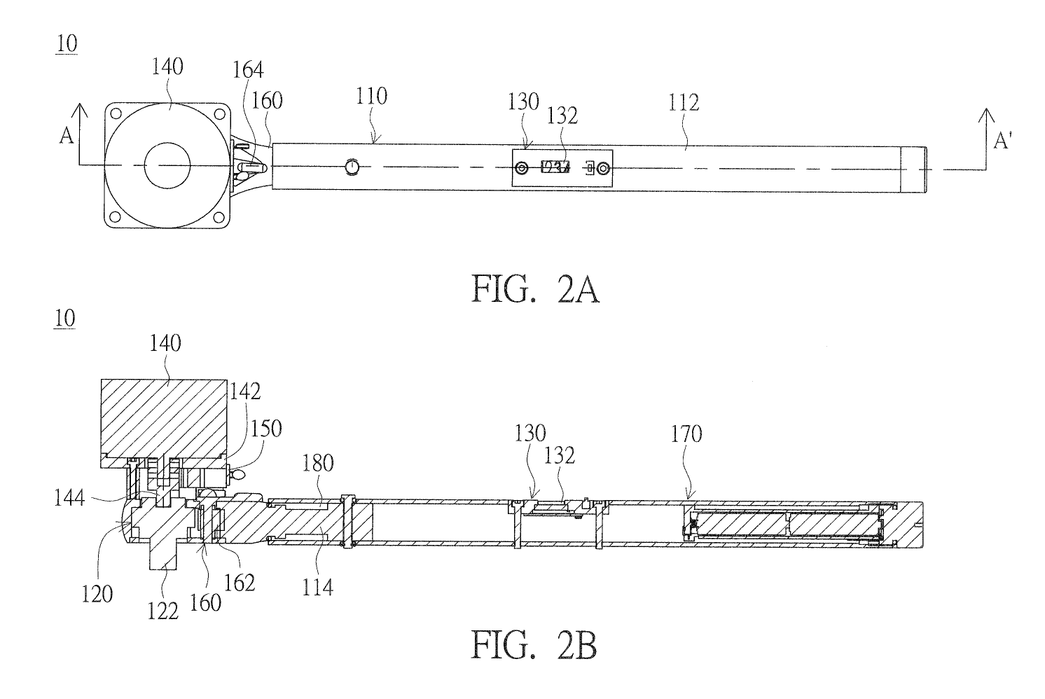

FIG. 2A is a top view showing a power wrench according to a first embodiment of the invention. As shown in FIG. 2A, the power wrench 10 externally includes a body 110 having a tube 112. Preferably, a digital module 130 is disposed on the tube 112. The digital module 130 includes a display unit 132 for displaying a value of a torque withstood by the power wrench 10.

FIG. 2B is a cross-sectional view taken along a line A-A′ of FIG. 2A. As shown in FIG. 2B, the power wrench 10 further includes a connecting element 120, which is disposed at one end of the tube 112 in the body 110, protrudes out of the tube 112, and is axially rotatable relative to the tube 112. Preferably, the portion of the connecting element 120 protruding out of the tube 112 includes a connection projection 122 to be combined with sleeves having different sizes to screw bolts having different sizes.

Referring to FIG. 2B, the power wrench 10 includes a drive motor 140, which is disposed on the connecting element 120 and is for rotating the connecting element 120. The power wrench 10 preferably includes a motor frame 142, which is disposed on the connecting element 120. An axial coupler 144 couples the connecting element 120 with a rotating shaft of the drive motor 140 so that the drive motor 140 can be removably disposed on the motor frame 142 and different drive motors with different output powers can be exchanged. However, the invention is not limited thereto, and the drive motor 140 may also be fixedly disposed on the connecting element 120.

In addition, one of ordinary skill in the art may easily understand that the invention is not limited thereto. A bearing, such as a roller bearing, may further be disposed between the connecting element 120 and the tube 112. Thus, no relative friction between the connecting element 120 and the tube 112 can be generated, and the lifetime of each of the connecting element 120 and the tube 112 can be lengthened.

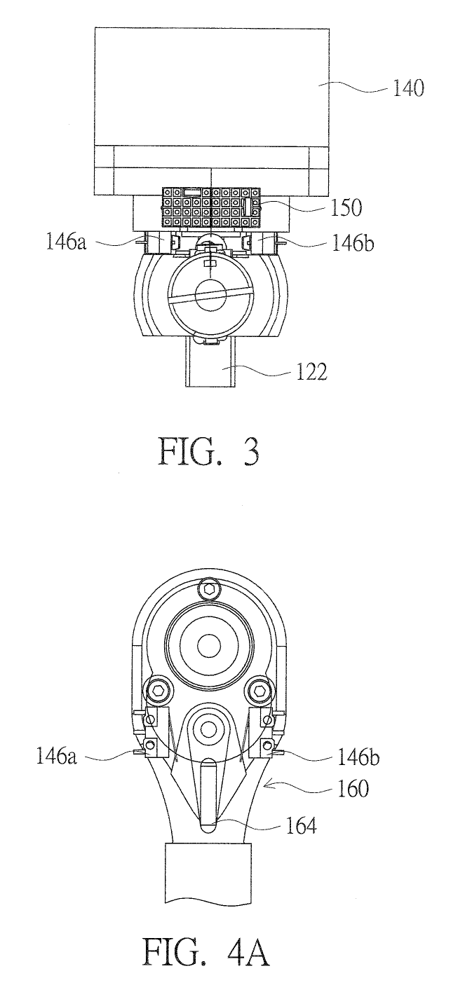

FIG. 3 is a side view showing a protection circuit of the motor. As shown in FIG. 3, the drive motor 140 of this embodiment preferably has a left touch switch 146a and a right touch switch 146b, which are respectively disposed at a lower left side and a lower right side of the drive motor 140, and are for controlling a rotation direction of the drive motor 140 so that the user can screw in or out the bolt.

As shown in FIGS. 2B and 3, the protection circuit 150, which is disposed adjacent to the drive motor 140 and electrically connected to the drive motor 140, is for controlling a power supply of the drive motor 140 according to a value of a drive current of the drive motor 140. The drive motor 140 may be a DC drive motor or an AC drive motor. The protection circuit is preferably an over-current protection element. Preferably, the critical current value of the protection circuit 150 is adjustable. That is, the instantaneous maximum output power of the drive motor 140 can be adjusted by the protection circuit 150 so that the user can control the reaction force at the instant when the screw-in stage ends. However, the invention is not limited thereto, and the protection circuit 150 may also be integrated inside the digital module 130.

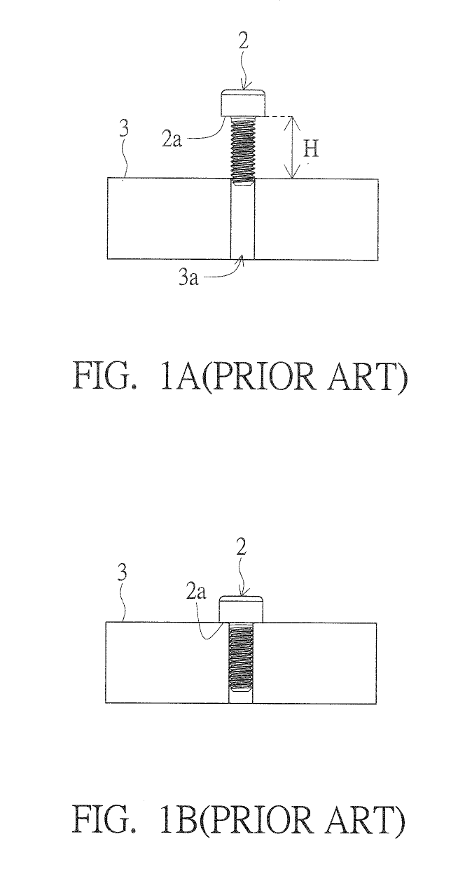

The power wrench 10 can effectively ease the hurt caused by the reaction force to the user according to the design of the protection circuit 150. In the following, illustrations will be made according to the screw-in stage and the tightly screwing stage of the bolt, as shown in FIGS. 1A and 1B. In the screw-in stage, as shown in FIG. 1A, the power wrench 10 can quickly screw the bolt 2 into the screw hole 3a of the work surface 3 using the drive motor 140. When the bolt bearing surface 2a of the bolt 2 touches the work surface 3, the drive current of the drive motor 140 is increased in order to keep the rotating speed of the drive motor 140 because the work surface 3 prevents the bolt 2 from being screwed in. When the drive current of the drive motor 140 is over the critical current value of the protection circuit 150, the protection circuit 150 cuts off the power supply of the drive motor 140 so that the too-large reaction force cannot be generated to hurt the user. In the subsequently tightly screwing stage, the user can manually screw the bolt tightly to precisely reach the default screwing intensity.

Referring to FIG. 2B, the power wrench 10 further includes a power module 170 for powering the drive motor 140 and the digital module 130. However, the invention is not limited thereto, and the drive motor 140 may also be powered by an external power source to provide the larger output power.

Referring again to FIG. 2B, the power wrench 10 further includes a sensing element 180 disposed on a supporting rod 114 to sense a strain of the supporting rod 114. Preferably, the sensing element 180 is a piezoresistive material or a strain gauge. The sensing element 180 is electrically connected to the digital module 130. Thus, the digital module 130 converts the value of the sensed strain of the supporting rod 114 into a value of a torque correspondingly withstood by the supporting rod 114 according to a signal outputted from the sensing element 180, and the value of the torque is displayed on the display unit 132. Therefore, when the user is performing a screwing operation, he or she can obtain the screwing intensity of the bolt from the display unit 132 and thus achieve the precise screwing operation.

Preferably, as shown in FIG. 2B, the connecting element 120 is connected to a limiting element 160. The limiting element 160 disposed on the supporting rod 114 of the body 110 is for limiting the rotation direction of the connecting element 120. In this embodiment, the limiting element 160 is preferably a ratchet head module disposed in the tube 112 of the body 110. The ratchet head module has a ratchet 162 engaged with the connecting element 120. Thus, it is possible to prevent the connecting element 120 from rotating relative to the body 110 in a certain direction so that the user can adjust the force applying position without separating the sleeve from the bolt and the bolt screwing operation can be performed more easily.

In addition, the ratchet head module of the embodiment of which the ratchet 162 may preferably be able to switch the rotation direction thereof. As shown in FIG. 2A, the limiting element 160 includes a limit switch 164 for switching the rotation direction of the ratchet 162. Therefore, when the user wants to use the power wrench 10 to screw out the bolt or to screw in the bolt with the reverse threads, he or she only has to switch the limiting direction of the ratchet using the limit switch 164 in a quite convenient manner.

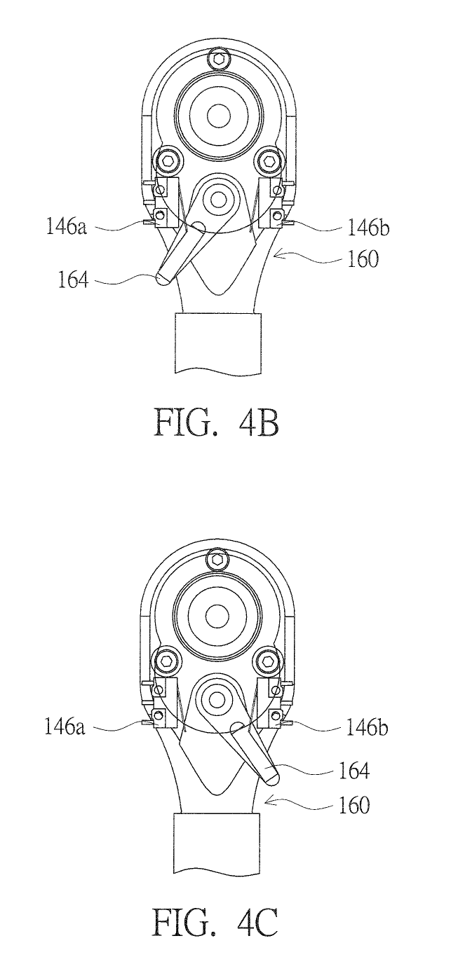

FIGS. 4A to 4C are schematic illustrations showing first to third switched states of the limit switch of the limiting element respectively. As shown in FIG. 4A, when the limit switch 164 is located at the middle position, the limit switch 164 does not contact with the left touch switch 146a and the right touch switch 146b respectively disposed at the left and right sides, and the drive motor 140 cannot rotate. As shown in FIG. 4B, when the limit switch 164 is switched to the left side to contact with the left touch switch 146a, the connecting element 120 is restricted by the limiting element 160 and only can be rotated counterclockwise (on the top view). Meanwhile, the limit switch 164 enables the drive motor 140 to rotate counterclockwise through the left touch switch 146a to enable the operation of screwing out the bolt or the operation of screwing in the bolt with the reverse threads. As shown in FIG. 4C, when the limit switch 164 is switched to the right side to contact with the right touch switch 146b, the connecting element 120 is restricted by the limiting element 160 and only can be rotated clockwise (on the top view). Meanwhile, the limit switch 164 enables the drive motor 140 to rotate clockwise through the right touch switch 146b to perform the operation of screwing in the bolt or the operation of screwing out the bolt with the reverse threads.

### Second Embodiment

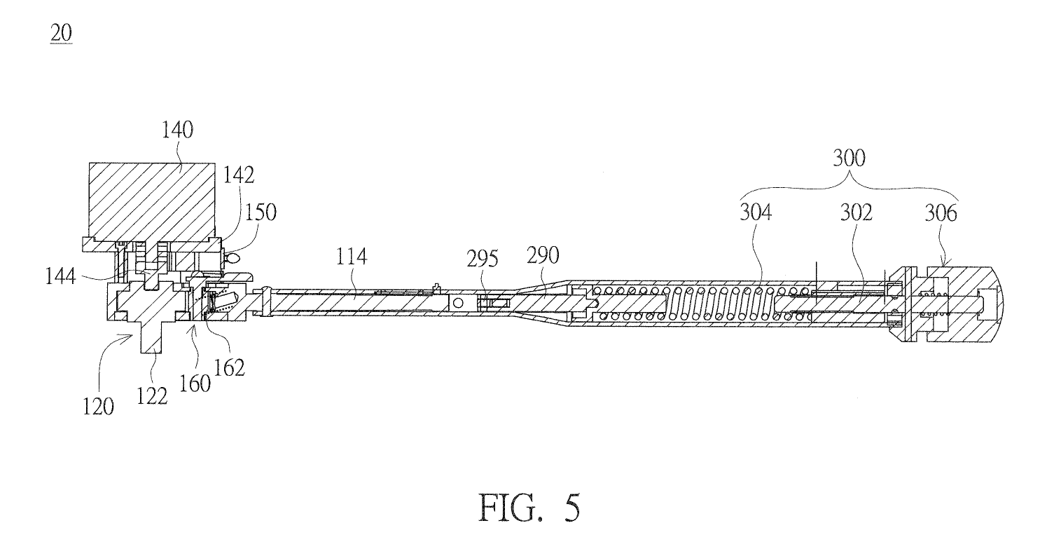

FIG. 5 is a cross-sectional view showing a power wrench 20 according to a second embodiment of the invention. As shown in FIG. 5, the difference between the power wrench 20 of the second embodiment and the power wrench 10 of the first embodiment is that the power wrench 20 includes a constant torque tripping mechanism. The other elements of the second embodiment are the same as those of the first embodiment, so detailed descriptions thereof will be omitted.

Referring to FIG. 5, the power wrench 20 includes a tripping mechanism 290, which can be relatively movably connected to the supporting rod 114. In this embodiment, the power wrench 20 preferably uses a link 295 for connecting the supporting rod 114 to the tripping mechanism 290.

Referring again to FIG. 5, a torque setting mechanism 300 includes a push block 302, a spring 304 and a torque adjusting module 306. The torque setting mechanism 300 applies a set torque to the tripping mechanism 290. The torque adjusting module 306 adjusts the value of the set torque, and the set torque is transmitted to the spring 304 through the push block 302 and then transmitted to the tripping mechanism 290 through the spring 304.

When the protection circuit 150 cuts off the power supply of the drive motor 140 to finish the screw-in stage, the user further screws the bolt tightly in the tightly screwing stage. At this time, the user only has to set the torque using the torque adjusting module 306. When the reaction force generated by manually screwing the bolt causes a torque larger than the torque set by the tripping mechanism 290, the instantaneous tripping feeling is generated on the hand, and the user knows that the bolt has reached the tightly screwed intensity so that the operation efficiency can be effectively enhanced.

The power wrench according to the embodiment of the invention has the drive motor and the protection circuit so that the user can quickly screw in the bolt using the power source with the large torque in the screw-in stage without worrying about that the reaction force, which is generated at the instant when the screw-in stage ends, will hurt the wrist. In the subsequently tightly screwing stage, the user can manually screw the bolt to reach the default intensity. If the power wrench of the invention further has the tripping mechanism, a constant torque power wrench can be provided to enhance the operation efficiency in the stage of manually screwing the bolt.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power wrench, comprising:
a body, wherein the body comprises a supporting rod;
a connecting element, which is axially rotatably disposed inside the body and protrudes out of the body;
a drive motor for rotating the connecting element;
a protection circuit for controlling a power supply of the drive motor according to a value of a drive current of the drive motor, wherein the protection circuit cuts off the power supply of the drive motor when the drive current of the drive motor is over a critical current value;
a tripping mechanism movably connected to the supporting rod; and
a torque setting mechanism for applying a set torque to the tripping mechanism when the protection circuit cuts off the power supply of the drive motor;
wherein when a torque withstood by the supporting rod is larger than the set torque from the torque setting mechanism, an instantaneous tripping of the tripping mechanism occurs.

2. The power wrench according to claim 1, further comprising a limiting element for limiting a rotation direction of the connecting element.

3. The power wrench according to claim 2, wherein the limiting element is disposed on the supporting rod and is connected to the connecting element, and the power wrench further comprises a sensing element, which is disposed on the supporting rod and is for sensing a strain of the supporting rod.

4. The power wrench according to claim 3, further comprising a digital module, which comprises a display unit for displaying a value of the torque withstood by the supporting rod according to a signal outputted from the sensing element.

5. The power wrench according to claim 3, wherein the sensing element is a piezoresistive material or a strain gauge.

6. (canceled)

7. The power wrench according to claim 1, wherein the body further comprises a link for connecting the supporting rod to the tripping mechanism.

8. The power wrench according to claim 1, wherein the torque setting mechanism comprises a torque adjusting module for adjusting a value of the set torque.

9. The power wrench according to claim 2, wherein the limiting element is a ratchet head module disposed in the body, and the ratchet head module has a ratchet engaging with the connecting element.

10. The power wrench according to claim 9, wherein the ratchet is able to switch a rotation direction of the ratchet.

11. The power wrench according to claim 10, wherein the ratchet head module comprises a limit switch for switching the rotation direction of the ratchet.

12. The power wrench according to claim 1, wherein the connecting element comprises a connection projection to be combined with sleeves having different sizes.

13. (canceled)

14. (canceled)

15. The power wrench according to claim 1, further comprising a switch for switching a rotation direction of the drive motor.

16. The power wrench according to claim 1, wherein the protection circuit is an over-current protection element.

17. The power wrench according to claim 1, further comprising a motor frame disposed on the connecting element, wherein the drive motor is removably disposed on the motor frame.

18. The power wrench according to claim 1, further comprising a power module for powering the drive motor.

19. The power wrench according to claim 1, wherein the drive motor is powered by an external power source.

20. The power wrench according to claim 1, wherein the drive motor is a DC drive motor or an AC drive motor.

21. The power wrench according to claim 1, wherein the critical current value of the protection circuit is adjustable.

22. The power wrench according to claim 1, wherein the drive motor is fixedly disposed on the connecting element.
